(19) United States
(12) Patent Application Publication
(10) Pub. No.: US 2005/0079292 A1
(43) Pub. Date: Apr. 14, 2005

(54) Grooved backing roller for coating

(75) Inventor: Scott C. Moose, Victor, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/686,277

(22) Filed: Oct. 14, 2003

(51) Int. Cl. B05D 3/12; B05C 5/00

(52) U.S. Cl. 427/356; 427/420; 118/325

(57) ABSTRACT

A method for coating a liquid composition from an applicator to a surface of a moving web, the web being conveyed along a path through a coating apparatus, the coating apparatus including a coating station for applying a coating to the surface of the web, the coating station including a backing roller for supporting the web and a coating hopper for depositing a liquid coating on the web, includes the steps of: wrapping the web in a partial wrap around the backing roller, the backing roller being provided with a relieved surface, the relieved surface having a pattern of circumferential grooves that provides venting of entrained air, the pattern having a geometry and depth such that any temperature gradient in the web caused by the circumferential grooves in the backing roller does not disturb the coating applied by the coating apparatus; providing a source of liquid coating composition for coating the web; and transporting the web past the coating station, where the liquid composition is applied to the surface of the web from the coating hopper, whereby the coating of liquid composition is not disturbed by temperature gradients in the web.

### FIELD OF THE INVENTION

The present invention relates to the use of surface patterns on a backing roller employed in a coating apparatus for coating a web with any of various kinds of liquid compositions.

### BACKGROUND OF THE INVENTION

In a typical web coating system, a web of substrate material to be coated is wound partially around a backing roller and a coating hopper is arranged adjacent the web to apply a bead of coating material across the web as the web is transported around the backing roller past the coating hopper. The moving web carries with it a boundary layer of air on the front side (the side to be coated) and the back side (the side facing the backing roller). For every conveyance system there exists a speed at which conveyance is limited by back surface air entrainment between the web and the conveying roller. If the surface of the backing roller is smooth and the moving web is conveyed around the roller, then an air film will arise between the web and roller, creating an air bearing between the two surfaces. This air film thickness (h) is a function of several parameters: 1) coating roller radius (R), 2) dynamic air viscosity (μ), 3) web speed (U_{w}), 4) roller speed (U_{R}), and 5) web tension per unit width (T) and is given by the following equation:

$$h = 0.643 {R ( \frac{6 μ ( {U}_{W} + {U}_{R} )}{T} )}^{2 / 3} \qquad Equation 1$$

For a given air viscosity and web tension, the air film thickness will increase with increasing web/roller speed and/or roller diameter. This increase in air film thickness results in decreased contact between the web and roller, with a concomitant loss in traction. If the speed is increased to the point that the air film thickness is of the same order or larger than the roughness of either the smooth roller surface or the surface of the web facing the roller, then traction will be lost completely, resulting in slippage of the roller against the web. This loss of traction can result in problems such as cinches, scratches, tension and speed variations. In addition to loss of traction, the entrained air film thickness between the web and roller will result in a change in the web-to-roller capacitance, causing a non-uniform charge deposition and possibly leading to a non-uniform coating, as described previously.

It is known to provide means to remove or exhaust the boundary layers of air being carried on the back surface of a web and the surface of a roller when the two come into contact, thereby increasing the tractional contact of the web with the roller. Such means may include, for example, a pressure-loaded nip roller urged toward the conveying roller, the web passing therebetween. However, use of a nip roller may not be particularly desirable for several reasons including: 1) additional mechanical complexity to the apparatus that increases cost and reduces reliability, 2) increased potential for creasing of the web, particularly with thin webs, and 3) possible marring of the surface of the web to be coated by the face-side nip roller, resulting in coating non-uniformities.

Such means may also include a relief pattern formed in the surface of the conveying roller into which the back-side boundary layer of air may be exhausted from the web and escape. See U.S. Pat. No. 3,405,855 issued Oct. 15, 1968 to Daly et al., for example. In this patent, Daly et al. teach the use of a roller having circumferential venting grooves and supporting land areas to vent air carried by the underside of the traveling web. It has been found that the use of such a grooved roller as a backing roller in a coating process can create temperature gradients in the web that lead to coating non-uniformities. Daly et al. deal with conveyance roller issues and do not addresses the issue of web temperature gradients with such a roller surface pattern.

There is a need therefore for an improved grooved backing roller for use in a web coating process that provides good conveyance and good temperature uniformity at high speeds.

### SUMMARY OF THE INVENTION

The need is met according to the present invention by providing a method for coating a liquid composition from an applicator to a surface of a moving web, the web being conveyed along a path through a coating apparatus, the coating apparatus including a coating station for applying a coating to the surface of the web, the coating station including a backing roller for supporting the web and a coating hopper for depositing a liquid coating on the web, that includes the steps of: wrapping the web in a partial wrap around the backing roller, the backing roller being provided with a relieved surface, the relieved surface having a pattern of circumferential grooves that provides venting of entrained air, the pattern having a geometry and depth such that any temperature gradient in the web caused by the circumferential grooves in the backing roller does not disturb the coating applied by the coating apparatus; providing a source of liquid coating composition for coating the web; and transporting the web past the coating station where the liquid composition is applied to the surface of the web from the coating hopper, whereby the coating of liquid composition is not disturbed by temperature gradients in the web.

### ADVANTAGES

The present invention has the advantage of being able to use a grooved backing roller to relieve entrapped air in a coating station, while avoiding any coating non-uniformities due to temperature gradients induced in the web by the grooves in the roller.

### BRIEF DESCRIPTION OF THE DRAWINGS

FIG. 1 is a schematic side view of a prior art bead coating apparatus useful with the present invention; and

FIG. 2 is a front view of a grooved backing roller according to the present invention.

### DETAILED DESCRIPTION OF THE INVENTION

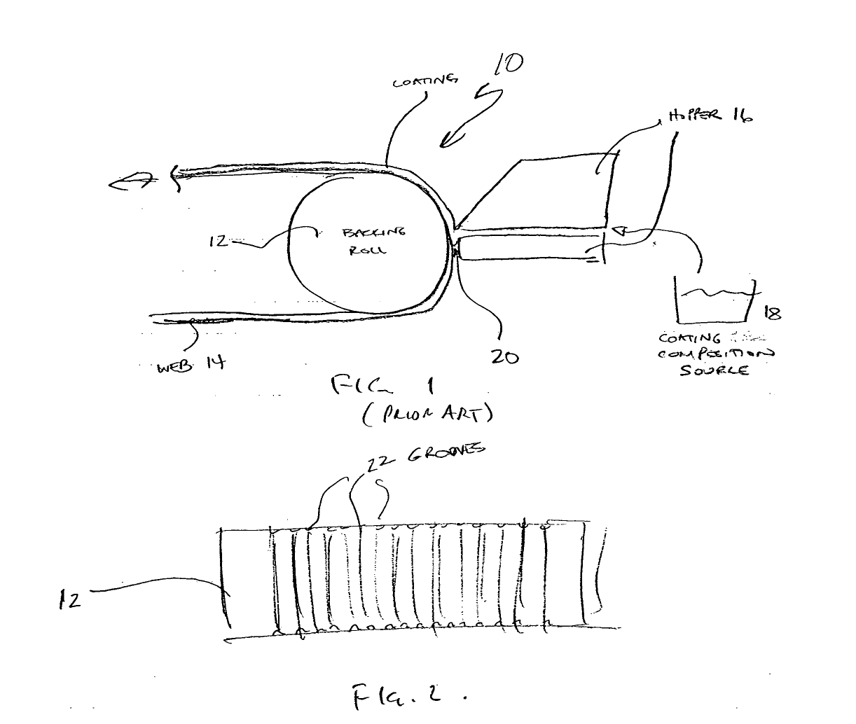

Referring to FIG. 1, a prior art bead coating apparatus 10 includes a backing roller 12, around which a web 14 is partially wrapped. A coating hopper 16 receives a flow of liquid coating composition from a source 18 and deposits a bead 20 of coating composition onto the surface of the web 14 as it is transported past the coating hopper 16 on the backing roller 12.

Referring to FIG. 2, according to the present invention, the backing roller 12 defines a series of circumferential grooves 22 for relieving air trapped between web 14 and backing roller 12. It has been found by the present invention that the use of such a grooved roller as a backing roller in a coating process can create temperature gradients in the web that lead to coating non-uniformities. It was also discovered through experimentation that if the frequency of the grooves is greater than a minimum frequency, the coating non-uniformities are avoided.

A solvent coating of polyvinyl butyral in methyl ethyl ketone with a dye was applied to a 4 mil polyester web using an extrusion hopper and grooved backing rollers having an average groove depth of 0.0025±0.001″ and 40, 70, 80, and 100 grooves per inch; 25 centipoise (cp) and 100 cp solutions were applied at 2 cc/square foot at 75° F. The grooved backing roller was tempered at 55° F. and 75° F. The coatings were dried and the relative transparencies (i.e. thicknesses) of the dried films were measured optically across the film in a direction perpendicular to the grooves by measuring the amount of light transmitted through the film.

An FFT (Fast Fourier Transformation) analysis was run on the transparency data from the dried coatings to determine whether high frequency lines matching 40, 70, 80, or 100 grooves per inch (gpi) could be detected in the dried films. Differences in film transparency (i.e. thicknesses) due to temperature gradients in the backing roller were observed only for the coatings made with the 40 gpi backing roller. The lines were less visible for the higher viscosity coatings and were also less visible when the difference between the temperature of the backing roller and the coating solution was minimized.

An additional set of experimental coatings were performed using a 100 gpi roller with 3 different coatings solutions (5 centipoise (cp), 25 cp, and 100 cp); and 2 different wet laydowns of each of the solutions; utilizing the coating roll at 3 different temperatures (55° F., 75° F., and 95° F.) to induce thermal gradients across the coating roll and hence the web. An FFT (Fast Fourier Transformation) analysis was run on the dried coatings to determine if high frequency lines matching 100 grooves per inch could be detected. No high frequency lines were detected.

Thus, it was concluded that the appearance of coating defects due to thermal gradients induced by a grooved backing roller can be avoided by employing a backing roller having a sufficiently high number of grooves per inch.

The invention has been described in detail with particular reference to certain preferred embodiments thereof, but it will be understood that variations and modifications can be effected within the spirit and scope of the invention.

### Parts List

10 coating apparatus
12 backing roller
14 web
16 coating hopper
18 liquid source
20 coating bead
22 circumferential grooves

1. A method for coating a liquid composition from an applicator to a surface of a moving web, the web being conveyed along a path through a coating apparatus, the coating apparatus including a coating station for applying a coating to the surface of the web, the coating station including a backing roller for supporting the web and a coating hopper for depositing a liquid coating on the web, comprising the steps of:
a) wrapping the web in a partial wrap around the backing roller, the backing roller being provided with a relieved surface, the relieved surface having a pattern of circumferential grooves that provides venting of entrained air, the pattern having a geometry and depth such that any temperature gradient in the web caused by the circumferential grooves in the backing roller does not disturb the coating applied by the coating apparatus;
b) providing a source of liquid coating composition for coating the web; and
c) transporting the web past the coating station, where the liquid composition is applied to the surface of the web from the coating hopper, whereby the coating of liquid composition is not disturbed by temperature gradients in the web.

2. The method claimed in claim 1, wherein the coating method is bead coating.

3. The method claimed in claim 2, wherein the pattern of circumferential grooves includes greater than 1.6 grooves per mm.

4. The method claimed in claim 1, wherein the grooves have a depth of 90 um.

5. The method claimed in claim 1, wherein the width of the relieved surface on the backing roller is equal to or greater than the width of the liquid coating to be applied to the web.

6. Apparatus for coating a liquid composition from an applicator to a surface of a moving web, the web being conveyed along a path through the coating apparatus, comprising: a coating hopper for delivering a liquid coating composition to the web; and a backing roller having a relieved surface having a pattern of circumferential grooves that provides venting of entrained air, the pattern having a geometry and depth such that any temperature gradient in the web caused by the circumferential grooves in the backing roller does not disturb the coating applied by the coating apparatus.

7. The apparatus claimed in claim 7, wherein the coating apparatus is a bead coating apparatus.

8. The apparatus claimed in claim 6, wherein the pattern of circumferential grooves includes at least 1.6 grooves per mm.

9. The apparatus claimed in claim 6, wherein the grooves have a depth of 90 um.

10. The apparatus claimed in claim 6, wherein the width of the relieved surface on the backing roller is equal to or greater than the width of the liquid coating to be applied to the web.
